(19) United States
(12) Patent Application Publication
(10) Pub. No.: US 2026/0316734 A1
(43) Pub. Date: Oct. 15, 2026

(54) ELECTROMECHANICAL BRAKE SYSTEM WITH REDUNDANT PNEUMATIC TRAILER CONTROL

(71) Applicant: ZF CV Systems Global GmbH, Bern (CH)

(72) Inventor: Julian Van Thiel, Grossburgwedel (DE)

(21) Appl. No.: 19/101,000

(22) PCT Filed: Aug. 5, 2022
(86) PCT No.: PCT/EP2022/072068

§ 371 Date: Feb. 4, 2025

(51) Int. Cl. B60T 13/68; B60T 8/17; B60T 13/26; B60T 17/00

(52) U.S. Cl. CPC B60T 13/683; B60T 8/1708; B60T 13/268; B60T 17/002; B60T 2270/402; B60T 2270/413

(57) ABSTRACT

A trailer control module (1) for an electromechanical brake system (202) of a tractor vehicle includes a primary electrical port (10) for receiving a primary electrical control signal (SS1) and a secondary electrical port (12) for receiving a secondary electrical control signal (SS2), and a valve arrangement (4) which, depending on the primary and secondary electrical control signals (SS1, SS2), outputs a trailer brake pressure (pBA). The valve arrangement (4) has a primary pilot control unit (6) receiving the primary control signals (SS1) and a secondary pilot control unit (8) receiving the secondary control signals (SS2). The primary pilot control unit (6) has a primary 3/2-way valve (16) as a primary inlet/outlet valve and the secondary pilot control unit (8) has a secondary 3/2-way valve (18) as a secondary inlet/outlet valve.

### FIELD

The present disclosure relates to a trailer control module for a brake system of a tractor vehicle having a trailer which includes a pneumatic brake system. The present disclosure also relates to an electromechanical brake system for a commercial vehicle and to a commercial vehicle.

### BACKGROUND

Brake systems, as are currently used for commercial vehicles, are generally pneumatic brake systems, which operate with compressed air. This is the case both for tractor vehicles and for trailers, wherein one or more compressed-air circuits are provided in the tractor vehicle, and the brake system of the tractor vehicle has valves in order to provide pneumatically actuable brake actuators at the wheels with compressed air in a targeted manner, in order in this way to bring about deceleration of the tractor vehicle. Trailers for such commercial vehicles also comprise a pneumatic brake system, but are supplied by an air-treatment unit from the tractor vehicle. For this purpose, both the tractor vehicle and the trailer have two pneumatic ports, namely a “reservoir” coupling head and a “brake” coupling head. Via the “reservoir” coupling head, reservoir pressure is provided from the tractor vehicle to the trailer vehicle and is then used in the trailer to fill a trailer reservoir provided therefor. By contrast, via the “brake” coupling head, a control pressure is transferred, which specifies the level of the brake pressure for the trailer.

With increasing electrification in the automotive sector, the brake system of tractor vehicles is also being electrified further. For this reason, in the last few years, electromechanical brake systems have increasingly been developed and used, which no longer operate with compressed air in the tractor vehicle, but control electric brake actuators, and in the case of which the deceleration of the tractor vehicle is effected by electromechanical actuators.

Nevertheless, there is a need to also continue to tow trailers that have a conventional pneumatic brake system with electrified tractor vehicles, and to control the pneumatic brake system of the trailer.

EP 3 822 133 A1 discloses a trailer control valve for this purpose. The trailer control valve comprises at least two electrical ports, which are designed to receive two independent, but redundant electrical control signals which have the signal for a preset brake control pressure, at least one valve, which is designed to set a constant air pressure of a compressed-air source to the preset brake control pressure, a brake reservoir pressure port, which is a pneumatic outlet and is designed to provide the preset brake reservoir pressure to the pneumatic trailer brake system, and a brake control pressure port, which is a second pneumatic outlet and is designed to provide the preset brake control pressure to the pneumatic brake system, wherein the compressed-air source is arranged within the trailer control valve.

Furthermore, EP 3 822 134 B1 discloses a trailer control module which is provided for a brake system of a motor vehicle having a trailer which comprises a pneumatic brake system which is designed to provide a preset brake control output pressure to the pneumatic brake system of the trailer. According to that disclosure, the trailer control module comprises at least two electrical ports, which are designed to receive two independent, but redundant electrical control input signals which comprise the signal for a preset brake control output pressure, at least one compressed-air source input, which is designed to receive compressed air from a compressed-air source, at least one valve, which is designed to adjust the constant air pressure from the compressed-air source to the preset brake output pressure, at least one brake supply pressure port, which is designed to provide the brake supply output pressure to the pneumatic brake system of the trailer, and at least one brake control pressure port, which is designed to provide the preset brake control output pressure to the pneumatic brake system of the trailer. The trailer control module disclosed therein is characterized in that it comprises at least two control solenoid groups, each of which comprises at least one load valve and at least one outlet valve, and forms a part of the control channel.

Even though both solutions work, further improvements are necessary, in particular in relation to installation space and a reduction in the individual components.

### SUMMARY

In a first aspect, the present disclosure solves the problem, in the case of a trailer control module for a brake system of a tractor vehicle having a trailer which includes a pneumatic brake system, as described herein. Such a trailer control module includes, according to the first aspect of the present disclosure, at least a first primary electrical port for receiving a primary electrical control signal, and a secondary electrical port for receiving a secondary electrical control signal. The primary and secondary electrical control signals are preferably redundant and independent of one another. They preferably include the signal for a preset trailer brake pressure. In normal operation, preferably only the primary electrical control signal is output. In the event that the primary electrical control signal cannot be provided or cannot be provided correctly if there is a fault, the trailer control module is preferably controlled on the basis of the secondary electrical control signal.

Furthermore, the trailer control module has, according to the first aspect of the present disclosure, preferably at least one reservoir port for receiving reservoir pressure from a compressed-air source, a trailer supply port for providing reservoir pressure for the pneumatic brake system of the trailer, and a trailer brake pressure port for providing a trailer brake pressure for the pneumatic brake system of the trailer. The trailer reservoir port is also referred to as the “reservoir coupling head” or “yellow coupling head”, while the trailer brake pressure port can also be referred to as the “brake coupling head” or “red coupling head”. The compressed-air source connected to this reservoir port to receive reservoir pressure is preferably the only compressed-air source of the brake system, since the brake system is preferably in the form of an electromechanical brake system.

Furthermore, the trailer control module has, according to the first aspect of the present disclosure, a valve arrangement which receives reservoir pressure from the reservoir port and, depending on the primary and secondary electrical control signals, outputs the trailer brake pressure at the trailer brake pressure port. The valve arrangement has a primary pilot control unit receiving the primary control signals and a secondary pilot control unit receiving the secondary control signals. The primary pilot control unit has a primary 3/2-way valve as a primary inlet/outlet valve and the secondary pilot control unit has a secondary 3/2-way valve as a secondary inlet/outlet valve.

The present disclosure is based on the finding that, even in an electromechanical brake system for a commercial vehicle that is electromechanically braked, a trailer control module can or should be provided, which allows the pneumatic control of the trailer. Since, however, an electromechanical brake system does not have further compressed-air reservoirs, but rather only electrically controls the brake actuators at the wheels, a trailer control module for such a brake system should likewise be controllable only electrically. For this purpose, the trailer control module according to the first aspect of the present disclosure is designed such that it can receive and implement the primary and secondary electrical control signals.

In contrast to the prior art, there is no separation between the load and outlet valve, rather a trailer module is proposed which provides a dedicated 3/2-way valve both for the primary electrical control signal and for the secondary electrical control signal, said 3/2-way valve acting as a combined inlet-outlet valve. In this way, the installation space can be reduced and a trailer control module which can process two separate, but redundant electrical control signals can be used with little installation space in modern electromechanical brake systems. The compressed-air source may be a compressed-air tank, a compressor and/or an electronic air-treatment unit, or some other unit which is suitable for providing compressed air. It may be accommodated next to the trailer control module in the brake system, in order in this way to reduce the number and length of pneumatic lines. In particular embodiments, it may be advantageous to directly integrate the inlet control module with the compressed-air source.

The primary and secondary electrical control signals are preferably provided by two independent control units, as will be described in more detail in the following text. It should be understood that the trailer control module according to the first aspect of the present disclosure is provided in particular for use in an electromechanical brake system and, in this regard, the reservoir port is preferably the only reservoir port and the compressed-air source is preferably connected only to the reservoir port and otherwise to no other consumers.

According to a first preferred embodiment, provision is made for the primary pilot control unit to have a primary pressure-holding valve for holding a primary control pressure output by the primary 3/2-way valve. Preferably, the secondary pilot control unit has a secondary pressure-holding valve for holding a secondary control pressure output by the secondary 3/2-way valve. The primary and secondary 3/2-way valves preferably each have first and second switch positions, wherein they are preferably each in the outlet or venting position in the first switch position and each in the ventilation or inlet or load position in the second switch position. This means that, to change between the ventilation and venting position and thus to provide an operating brake pressure for the trailer, it is necessary for the primary and secondary 3/2-way valves each to be switched back and forth between their switch positions. In order in this case to reduce the switching work, the primary and secondary pressure-holding valves are provided, which can reduce the switching work of the primary and secondary 3/2-way valves in particular in the case of stepped venting. The primary and secondary pressure-holding valves are also preferably controlled via the primary and secondary control signals.

In a preferred development, the trailer control module has a main valve unit which is connected to the reservoir port and receives reservoir pressure therefrom, and which is connected to the primary pilot control unit and to the secondary pilot control unit and receives the primary control pressure and the secondary control pressure therefrom and, depending on the primary control pressure and the secondary control pressure, outputs the trailer brake pressure at the trailer brake pressure port. According to this embodiment, the main valve unit is thus controlled both by the primary pilot control unit and by the secondary pilot control unit. Two main valve units, for instance a primary and a secondary main valve unit, are not provided, but rather a common main valve unit for both pilot control units, which, regardless of whether the trailer brake pressure is demanded via the primary control pressure or the secondary control pressure, outputs the trailer brake pressure at the trailer brake pressure port. As a result of this, too, it is possible to reduce components and thus also the installation space.

Preferably, the primary 3/2-way valve has a first 3/2-way valve port that is connected or connectable to the reservoir port, a second 3/2-way valve port that is connected or connectable to a vent, and a third 3/2-way valve port that is connected to a first control pressure line. In a first, deenergized switch position of the primary 3/2-way valve, the second 3/2-way valve port is preferably connected to the third 3/2-way valve port. Preferably, in a second, energized switch position of the primary 3/2-way valve, the first 3/2-way valve port is connected to the third 3/2-way valve port in order to output the primary control pressure into the first control pressure line. Similarly, the secondary 3/2-way valve preferably has a fourth 3/2-way valve port that is connected or connectable to the reservoir port, a fifth 3/2-way valve port that is connected or connectable to a vent, and a sixth 3/2-way valve port that is connected to a second control pressure line. In a first, deenergized switch position of the secondary 3/2-way valve, the fifth 3/2-way valve port is preferably connected to the sixth 3/2-way valve port. In a second, energized switch position of the secondary 3/2-way valve, the fourth 3/2-way valve port is preferably connected to the sixth 3/2-way valve port in order to output the secondary control pressure into the second control pressure line. Both the primary and the secondary 3/2-way valve are preferably formed in a monostable manner and, according to the described embodiment, are preferably deenergized in the venting position. In particular embodiments, however, provision may also be made for the primary and secondary 3/2-way valves each to be formed in a bistable manner and in this regard to have two stable rest positions.

Preferably, the main valve unit has a relay valve, having a first relay valve port that is connected or connectable to the reservoir port, a second relay valve port that is connected to the trailer brake pressure port and outputs the trailer brake pressure, a third relay valve port that is connected to a vent, and at least one first relay valve control port for receiving the primary control pressure. The secondary control pressure can either likewise be output at the first relay valve control port, or the relay valve has a second relay valve control port, which is then provided separately for the secondary control pressure. It is also possible to couple in the primary and secondary control pressure via, for example, a select-high valve at the first relay valve control port.

In a further preferred configuration, provision is made for the trailer control module to have a breakaway emergency valve which is arranged pneumatically at least between the reservoir port and the trailer supply port. Such a breakaway emergency valve serves, in the event that the red and/or yellow coupling head is separated, to prevent further output of the trailer brake pressure at the trailer supply port, in order to prevent the compressed air reservoir running dry.

Preferably, the primary switching signals are provided by a primary electronic control unit and the secondary switching signals are provided by a secondary electronic control unit, wherein the primary and the secondary electronic control unit are independent of one another and can provide redundancy and functionally replace one another at least partially. For example, the secondary electronic control unit is a control unit which is provided for an electronic redundancy level of the brake system. The secondary electronic control unit can also be integrated with the trailer control module, in order to save more installation space.

Alternatively, provision may also be made for the trailer control module to be integrated with an electronic air-treatment unit of the brake system. This is particularly advantageous, because the brake system as a whole is in the form of an electromechanical brake system.

In a second aspect, the present disclosure solves the problem mentioned at the outset with an electromechanical brake system for a commercial vehicle as described herein. According to the second aspect of the present disclosure, the electromechanical brake system has a primary electronic control unit and a secondary electronic control unit, a first power source, which supplies the primary control unit with electric power, and a second power source, which supplies the secondary control unit with electric power. In this way, independence of the primary and second control unit is achieved. The electromechanical brake system has at least a first and second electromechanical front-axle brake actuator and at least a first and second electromechanical rear-axle brake actuator, which are controllable by the primary control unit and the secondary control unit in order to implement a brake demand. It also has a trailer control module, which is configured in accordance with one of the above-described embodiments of a trailer control module according to the first aspect of the present disclosure, wherein the primary control unit is connected to the primary electrical port and provides the primary switching signals at the latter. Furthermore, the secondary control unit is connected to the secondary electrical port and provides the secondary switching signals at the latter.

It should be understood that the trailer control module according to the first aspect of the present disclosure and the electromechanical brake system according to the second aspect of the present disclosure have identical and similar sub-aspects, as are set out herein. In this regard, reference is made in full to the above description of the first aspect of the present disclosure.

Preferably, the trailer control module has a trailer control module housing and is constructed as an independent module in the brake system. Alternatively, the trailer control module and the secondary control unit are integrated to form a module. As a further alternative, the electromechanical brake system has an electronic air-treatment unit, wherein the trailer control module and the electronic air-treatment unit are integrated to form a module.

In a third aspect, the present disclosure solves the problem mentioned at the outset with a commercial vehicle as described herein. The commercial vehicle has a front axle, at least one rear axle, and an electromechanical brake system according to any of the preferred embodiments of the electromechanical brake system according to the second aspect of the present disclosure. Again, it should be understood that the electromechanical brake system according to the second aspect of the present disclosure, the trailer control module according to the first aspect of the present disclosure, and the commercial vehicle according to the third aspect of the present disclosure have identical and similar sub-aspects, as are set out herein. In this regard, reference is made in full to the above description of the first and second aspects of the present disclosure.

Embodiments of the present disclosure will now be described in the following text with reference to the drawings. These are intended to illustrate the embodiments not necessarily to scale; rather the drawings, where this is useful for explanation, are in a schematic and/or slightly distorted form. With regard to additions to the teachings that are directly identifiable from the drawings, reference is made to the relevant prior art. It should be noted that many modifications and changes relating to the form and detail of an embodiment can be carried out without deviating from the general idea of the present disclosure. The features of the present disclosure that are disclosed in the description, the drawings and the claims can be essential to the development of the present disclosure both individually and in any desired combination. Moreover, all combinations of at least two of the features that are disclosed in the description, the drawings and/or the claims are covered by the scope of the present disclosure. The general idea of the present disclosure is not limited to the exact form or detail of the preferred embodiments that are shown and described in the following text, or limited to subject matter that would be limited compared to the subject matter claimed in the claims. Where ranges of measurements are indicated, values lying within the mentioned limits are also intended to be disclosed as limit values and to be usable and utilizable as desired. For the sake of simplicity, the same reference signs are used in the following text for identical or similar parts or parts with an identical or similar function.

### BRIEF DESCRIPTION OF THE DRAWINGS

Further advantages, features and details of the present disclosure will become apparent from the following description of the preferred embodiments and from the drawings, in which:

FIG. 1 shows a schematic illustration of a trailer control module in a first exemplary embodiment;

FIG. 2 shows a schematic illustration of a trailer control module in a second exemplary embodiment;

FIG. 3 shows a schematic illustration of a trailer control module in a third exemplary embodiment;

FIG. 4 shows a schematic illustration of an electromechanical brake system in a first exemplary embodiment;

FIG. 5 shows a schematic illustration of an electromechanical brake system in a second exemplary embodiment; and

FIG. 6 shows a schematic illustration of an electromechanical brake system in a third exemplary embodiment.

### DETAILED DESCRIPTION

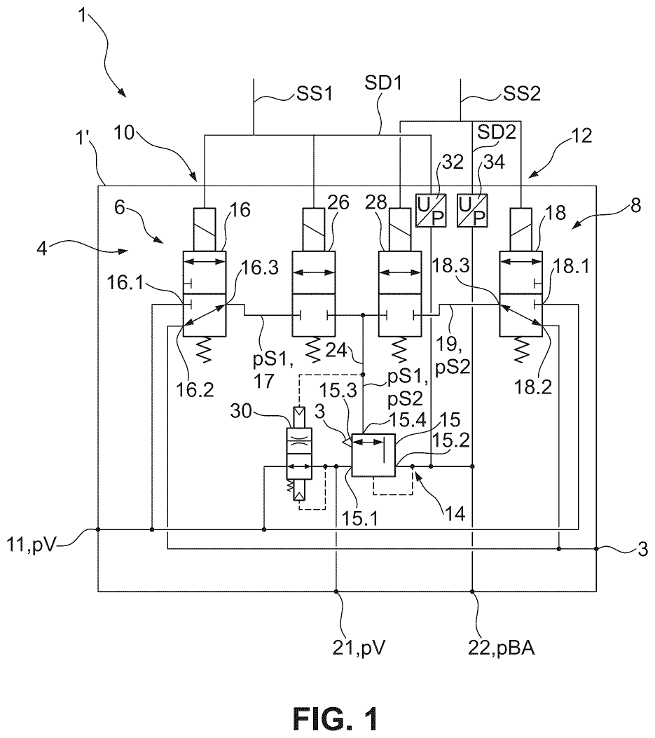

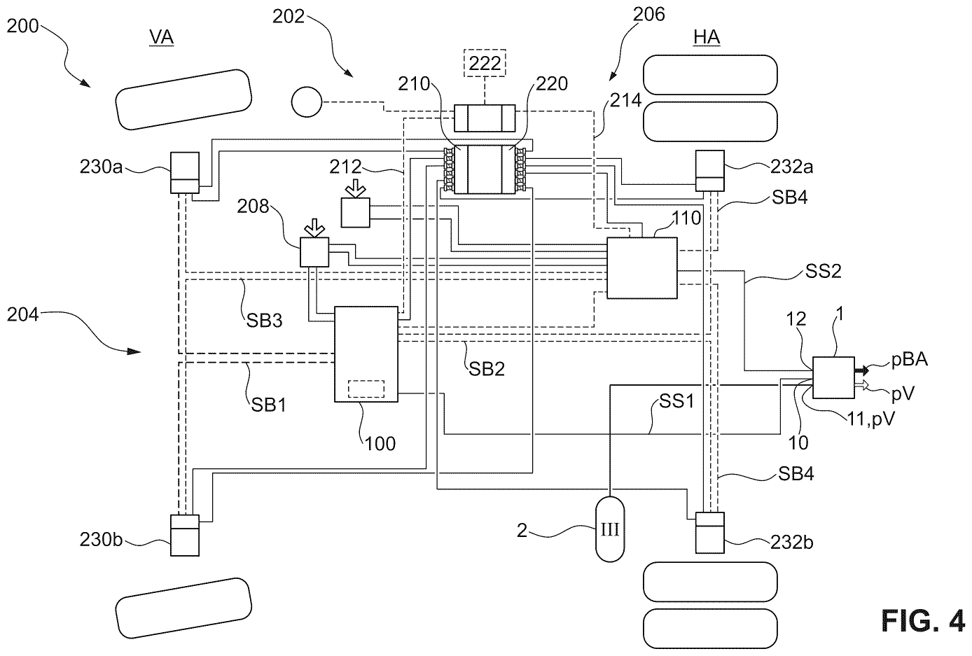

FIG. 1 shows a first exemplary embodiment of a trailer control module 1 according to the present disclosure. The trailer control module 1 is in this case shown with a separate trailer control module housing 1′ and has a primary electrical port 10 and a secondary electrical port 12 as electrical ports. Furthermore, the trailer control module 1 has pneumatic ports, namely a reservoir port 11, which is connected to a compressed-air source 2 (cf. FIGS. 4 to 6), a trailer supply port 21, which is connected to a “yellow coupling head”, and a trailer brake pressure port 22, which is connected to a “red coupling head”. For venting, the trailer control module 1 also has a vent 3.

The trailer control module 1 is provided for an electromechanical brake system 202 of a commercial vehicle 200 (cf. FIGS. 4 to 6) and is intended to be controlled only electrically in the exemplary embodiment shown here (FIGS. 1 to 3). Pneumatic redundancy or the like is not provided here, even if this may be conceivable in principle and even preferred in some embodiments.

In order to implement primary electrical control signals SS1 provided at the primary electrical port 10 and to implement secondary electrical control signals SS2 provided at the secondary electrical port 12, the trailer control module has a plurality of pneumatic or electropneumatic valves, which are jointly referred to as a valve arrangement 4. The valve arrangement 4 includes, in the exemplary embodiment shown here (FIG. 1), a primary pilot control unit 6 and a secondary pilot control unit 8. The primary pilot control unit 6 is connected to the primary electrical port 10 and is controlled on the basis of the primary electrical control signals SS1. The secondary pilot control unit 8 is connected to the secondary electrical port 12 and is controlled on the basis of the secondary electrical control signals SS2. The primary pilot control unit 6 serves to provide a primary control pressure pS1 and the secondary pilot control unit 8 serves to provide a secondary control pressure pS2, which are each independent of the primary and secondary electrical control signals SS1, SS2.

The primary pilot control unit 6 and the secondary pilot control unit 8 provide the primary and secondary control pressure pS1, pS2, respectively, at a main valve unit 14, which in this case has a relay valve 15. Both the primary and the secondary control pressure pS1, pS2 are provided at the relay valve 15 and a separate main valve unit is not provided for each pilot control unit 6, 8; rather, the present disclosure uses a common main valve unit 14 for both the primary and the secondary pilot control unit 6, 8. The main valve unit 14 then implements the primary and secondary control pressure pS1, pS2, respectively, and, on the basis of this, outputs the trailer brake pressure pBA at the trailer brake pressure port 22.

More specifically, the primary pilot control valve 6 has, in the exemplary embodiment shown in FIG. 1, a primary 3/2-way valve 16 as a combined inlet-outlet valve, and in this case also an optional primary pressure-holding valve 26. The primary 3/2-way valve has a first 3/2-way valve port 16.1, which is connected to the reservoir port 11 and receives reservoir pressure. The primary 3/2-way valve 16 has a second 3/2-way valve port 16.2, which is connected to the vent 3. A third 3/2-way valve port 16.3 of the primary 3/2-way valve 16 is connected to a first control pressure line 17 and outputs the primary control pressure pS1 in the latter. The primary pressure-holding valve 26, which is in the form of a 2/2-way valve, in particular of a monostable 2/2-way valve, is also inserted into the first control pressure line 17. In the switch position shown in FIG. 1, the deenergized switch position, it is closed, while it is opened in an energized state and can conduct the primary control pressure pS1.

The secondary pilot control unit 8 is also constructed in a similar manner, having a secondary 3/2-way valve as a combined inlet-outlet valve, and optionally a secondary pressure holding valve 28. The secondary 3/2-way valve has a fourth 3/2-way valve port 18.1, which is connected to the reservoir port 11 and receives reservoir pressure. The secondary 3/2-way valve 18 has a fifth 3/2-way valve port 18.2, which is connected to the vent 3. A sixth 3/2-way valve port 18.3 is connected to the second control pressure line 19 and outputs the secondary control pressure pS2 in the latter. The secondary pressure-holding valve 28, which is in the form of a monostable 2/2-way valve, is also inserted into the second control pressure line 19, and is stable and deenergized in the switch position shown in FIG. 1, while it can be transferred, when in an energized state, into the second, opened switch position.

The first and second control pressure line 17, 19 open, downstream of the primary and secondary pressure-holding valve 26, 28, respectively, into a common control pressure line 24 in the exemplary embodiment shown in FIG. 1. The common control pressure line 24 is then connected to a first relay valve control port 15.4 of the relay valve 15. The relay valve 15 furthermore has a first relay valve port 15.1, which is connected or connectable to the reservoir port 11 and receives reservoir pressure pV from the latter. A second relay valve port 15.2 can also be understood as being a working port and is connected to the trailer brake pressure port 22 in order to output the trailer brake pressure pBA at the latter. A third relay valve port 15.3 is connected to the vent 3. Connected between the reservoir port 11 and the first relay valve port 15.1, in a manner known per se, is a breakaway emergency valve 30, which is arranged and connected such that, in the event of a sudden pressure drop at the trailer supply port 21 or at the trailer brake pressure port 22, it drops into a throttled switch position in order to prevent the compressed-air source 2 connected to the reservoir port 11 running dry.

Also shown in FIG. 1 are a primary pressure sensor 32 and a secondary pressure sensor 34, which respectively sense the output trailer brake pressure pBA. The primary pressure sensor 32 provides a primary pressure signal SD1 and the secondary pressure sensor 34 provides a secondary pressure signal SD2. The pressure sensors 32, 34 are thus embodied in a redundant manner here.

The trailer control module housing 1′ is only optional and it should be understood that the valve arrangement 4 can also be integrated into other functional units of the electromechanical brake system 202, as is described in more detail with reference to FIGS. 4 to 6.

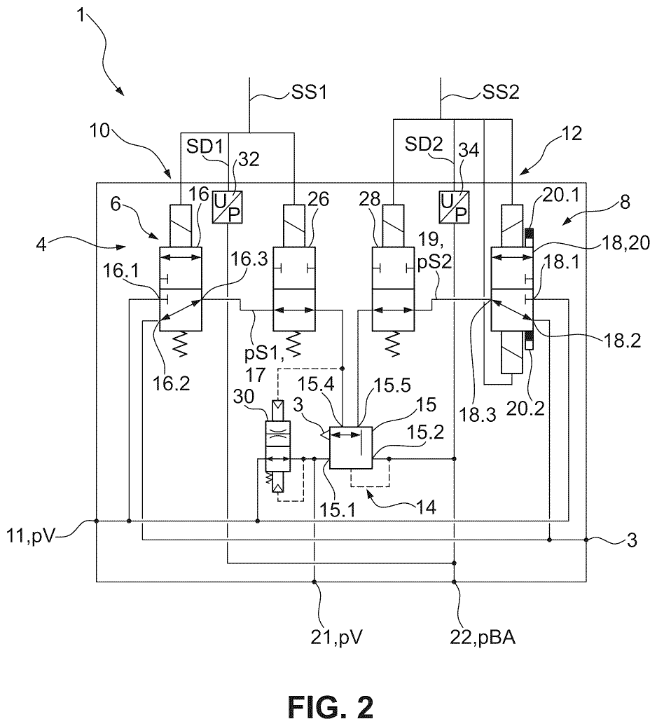

FIG. 2 now shows a variant of the trailer control module in FIG. 1 and identical and similar elements are provided with the same reference signs as in FIG. 1. In the following text, in particular the differences from the first exemplary embodiment (FIG. 1) are highlighted. Commonalities between the two exemplary embodiments are not particularly emphasized.

A first difference is that the secondary 3/2-way valve 18 is in the form of a bistable valve 20 with two magnetic rest positions. This is indicated by the two electromagnets 20.1, 20.2, which can be controlled, in this case on the basis of the secondary electrical control signal SS2. A bistable valve has two stable rest positions, that is to say rest positions that can be maintained in a deenergized state, such that both the switch position of the bistable valve 20 that is shown in FIG. 2 and the switch position thereof that is not shown in FIG. 2 can be held in a deenergized state. This configuration is advantageous in particular in order to brake the trailer (not shown) in the stopped state of the commercial vehicle 200 and to keep it in the parked state. The bistable valve 20 is capable of maintaining the switch position that is not shown in 2 in a deenergized state and thus to also durably output the secondary control pressure pS2 in a deenergized state, in order to also demand the trailer brake pressure pBA in a deenergized state.

A further difference, which is independent of the difference that has just been described, is that a common control pressure line 24 is not provided, but rather the first and second control pressure lines 17, 19 are guided continuously as far as the relay valve 15. The first control pressure line 17 is connected there to the first relay valve control port 15.4, while the second control pressure line 19 is connected to a second relay valve control port 15.5. The first and the second relay valve control port 15.4, 15.5 can act on the same relay piston, preferably on the same relay surface, or separate control surfaces are provided for the first and second relay valve control ports 15.4, 15.5. An advantage of this arrangement is that the primary and secondary pressure-holding valves 26, 28 do not absolutely have to be closed in order to output the respectively other control pressure. Thus, it is possible, as illustrated in FIG. 2, for the optional primary and secondary pressure-holding valves 26, 28 to be open in a deenergized state, while they are closed only in an energized state. As a result, the power consumption as a whole can be reduced and switching operations can be eliminated.

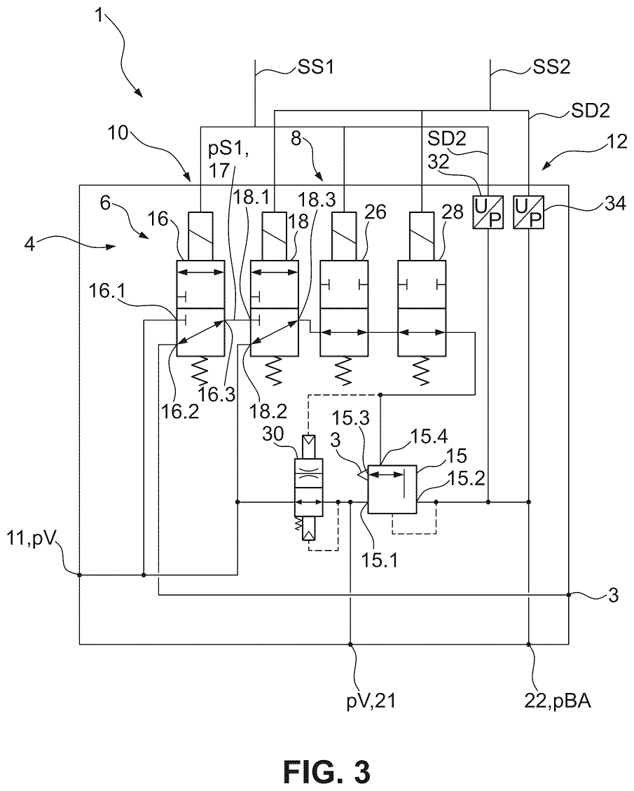

A third embodiment, illustrated in FIG. 3, of the trailer control module 1 is in turn based on the previous embodiments (FIGS. 1 and 2), and identical and similar elements are again provided with the same reference signs. Here too, in particular the differences from the first two exemplary embodiments are highlighted, while commonalities are not emphasized further.

The main difference from the first exemplary embodiment (FIG. 1) resides, in the third exemplary embodiment (FIG. 3), in the arrangement of the primary and secondary pilot control units 6, 8. While the primary and secondary pilot control units 6, 8 in FIG. 1 and in particular also in FIG. 2 are provided on pneumatically separate paths, they are interconnected in FIG. 3. In particular, the secondary 3/2-way valve 18 is arranged pneumatically downstream of the primary 3/2-way valve 16, i.e., although the primary 3/2-way valve 16 outputs the first control pressure pS1 into the first control line 17, this is then initially connected to the secondary 3/2-way valve 18, and so it is necessary for the secondary 3/2-way valve 18 to be put into the second switching position (not shown in FIG. 1) in order for it to be possible to conduct the first control pressure pS1. In this way, a safety level can be introduced, and it is possible to prevent the primary and secondary control pressures pS1, pS2 being added together at the relay valve 15, but rather they can each be output only alternately. The primary and secondary pressure-holding valves 26, 28 are, as before, illustrated separately, but provision could also be made for them to be integrated into a single valve which can then be controlled both by the primary and by the secondary electrical control signal SS1, SS2.

An exemplary embodiment of an electromechanical brake system 202 of a commercial vehicle 200 is illustrated in FIG. 4.

An electromechanical brake system 202 is provided for a commercial vehicle 200, which is in the form of a two-axle commercial vehicle 200 here and has a front axle VA and a rear axle HA. It should be understood that such commercial vehicles 200 may also have a second rear axle, and may, as a whole, be in the form of multi-axle vehicles. The electromechanical brake system 202 has a primary operating level 204 and a secondary redundancy level 206, which, if the operating level 204 is not operational or not correctly operational, can take on the deceleration of the commercial vehicle 200. The primary operating level 204 is fed by a first power source 210 and includes a primary electronic control unit 100. The primary electronic control unit 100 is connected, via a primary vehicle bus 212, to further units of the commercial vehicle 200, for example a unit for autonomous driving 222, in order to receive trajectories, brake requests or maneuvers therefrom and implement them. The electromechanical brake system 202 additionally includes a brake signal transmitter 208, which may, for example, be in the form of an electric brake pedal. The brake signal transmitter 208 is connected, in a manner known per se, to the primary electronic control unit 100. The primary electronic control unit 100 is also connected to first and second electromechanical front-axle brake actuators 230a, 230b and first and second electromechanical rear-axle brake actuators 232a, 232b, and provides control signals SB1, SB2 at these. In the secondary redundancy level 206, the electromechanical brake system 202 includes a secondary electronic control unit 110, which can functionally replace the primary electronic control unit 100 at least partially. The secondary electronic control unit 110 takes on the control of the electromechanical brake system 202 if the primary electronic control unit 100 is not operating or not operating correctly. The secondary electronic control unit 110 is likewise connected to the brake signal transmitter 208 and receives, via a secondary vehicle bus 214, signals from further units, such as, in particular, the unit for autonomous driving 222. The secondary electronic control unit 110 is also connected to the first and second electromechanical front-axle brake actuators 230a, 230b and the first and second electromechanical rear-axle brake actuators 232a, 232b and can, in the event of redundancy, provide redundant control signals SB3, SB4 at these. The first and second electromechanical front-axle brake actuators 230a, 230b and the first and second electromechanical rear-axle brake actuators 232a, 232b are, for this purpose, connected both to the first and to the second power source 210, 220.

The electromechanical brake system 202 is designed to control a trailer (not shown). For this purpose, the electromechanical brake system 202 includes the trailer control module 1, which makes it possible to also control conventional trailers having a purely pneumatic trailer brake system.

The primary electrical port 10 of the trailer control module 1 is connected to the primary electronic control unit 100 and receives the primary electrical control signals SS1 therefrom. The secondary electrical port 12 is connected to the secondary electronic control unit 110 and receives the secondary electrical control signals SS2 therefrom. This means that both in normal operation, when the electromechanical brake system 202 is controlled by the primary electronic control unit 100, and in redundancy operation, when the electromechanical brake system 202 is controlled by the secondary electronic control unit 110, the trailer can be controlled via the trailer control module 1. In FIG. 4, a compressed-air source 2 in the form of a compressed-air reservoir is shown, which has to be connected to an air-treatment unit (not shown here) or the like in order to accordingly fill the latter with compressed air.

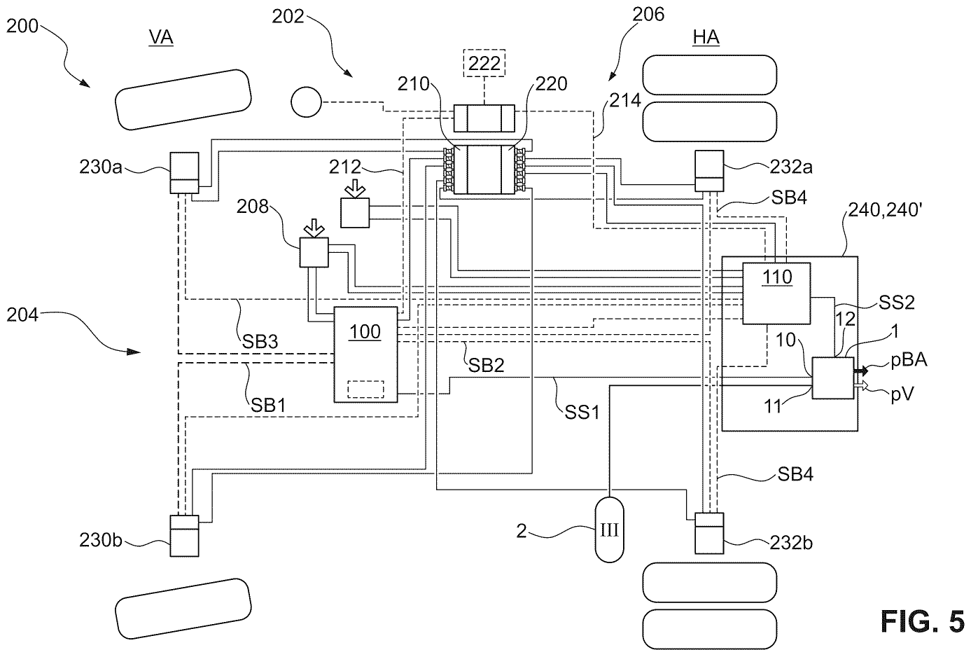

The second exemplary embodiment of the electromechanical brake system 202 (FIG. 5) is based on the first exemplary embodiment (FIG. 4), and identical and similar elements are again provided with the same reference signs, and so reference is made in full to the description of FIG. 4. In the following text, too, in particular the differences are highlighted. The most important difference in the second exemplary embodiment of the electromechanical brake system 202 is that the trailer control module 1 is integrated with the secondary electronic control unit 110 to form a module. The integrated module 240 has a module housing 240′, and so, for example, the electric line, via which the secondary electronic control signals SS2 are provided by the secondary electronic control unit 110, extends only internally within the integrated module 240. In this way, installation space can be saved and the footprint of the brake system 202 as a whole can be reduced.

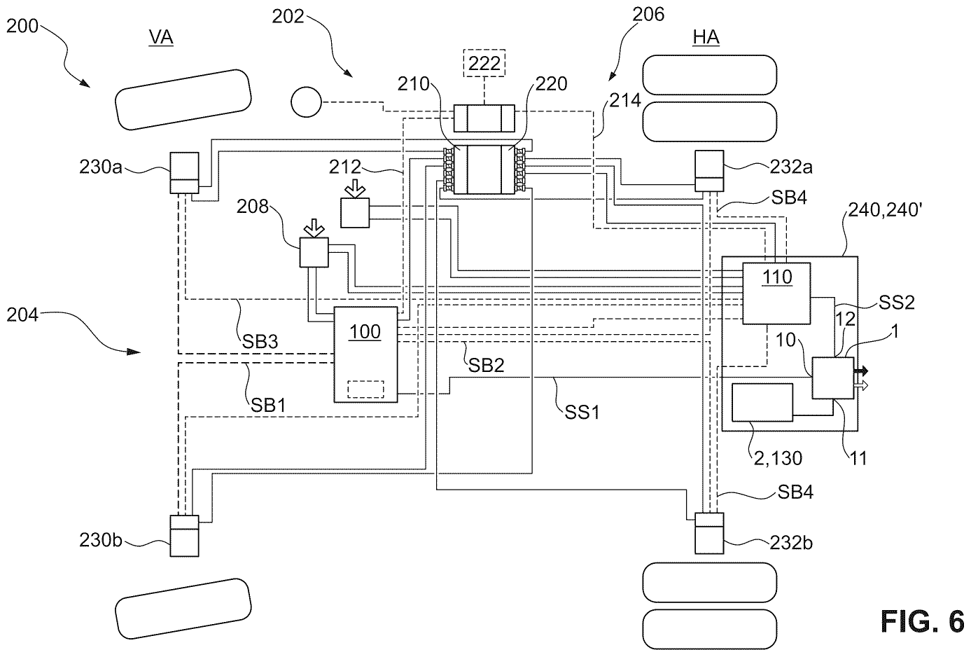

The third exemplary embodiment (FIG. 6) of the electromechanical brake system 202 is based on the second exemplary embodiment (FIG. 5), wherein, in this case, an electronic air-treatment unit 130 is additionally provided, which, in this case, is additionally integrated into the integrated module 240. In this regard, the integrated module 240 also no longer requires an external port for reservoir pressure, as is the case for the compressed-air source 2 in the exemplary embodiment shown in FIG. 5. Rather, pneumatic lines and connections can extend only within the integrated module 240, with the result that wiring and installation space can be saved. In this case, it should be understood that, although FIG. 6 illustrates that both the air-treatment unit 130 and the trailer control module 1 and the secondary electronic control unit 110 have been integrated to form the integrated module 240, there may also be embodiments in which only the trailer control module 1 and the electronic air-treatment unit 130 are formed together in an integrated manner.

### REFERENCE SIGNS (PART OF THE DESCRIPTION)

1 Trailer control module
1′ Trailer control module housing
2 Compressed-air source
3 Vent
4 Valve arrangement
6 Primary pilot control unit
8 Secondary pilot control unit
10 Primary electrical port
11 Reservoir port
12 Secondary electrical port
14 Main valve unit
15 Relay valve
15.1 First relay valve port
15.2 Second relay valve port
15.3 Third relay valve port
15.4 First relay valve control port
15.5 Second relay valve control port
16 Primary 3/2-way valve
16.1 First 3/2-way valve port
16.2 Second 3/2-way valve port
16.3 Third 3/2-way valve port
17 First control pressure line
18 Secondary 3/2-way valve
18.1 Fourth 3/2-way valve port
18.2 Fifth 3/2-way valve port
18.3 Sixth 3/2-way valve port
19 Second control pressure line
20 Bistable valve
21 Trailer supply port
22 Trailer brake pressure port
24 Common control pressure line
26 Primary pressure-holding valve
28 Secondary pressure-holding valve
30 Breakaway emergency valve
32 Primary pressure sensor
34 Secondary pressure sensor
100 Primary electronic control unit
110 Secondary electronic control unit
130 Electronic air-treatment unit
200 Commercial vehicle
202 Electromechanical brake system
204 Primary operating level
206 Secondary redundancy level
208 Brake signal transmitter
210 First power source
212 Primary vehicle bus
214 Secondary vehicle bus
220 Second power source
222 Unit for autonomous driving
230a, 230b First and second electromechanical front-axle brake actuators
232a, 232b First and second electromechanical rear-axle brake actuators
240 Integrated module
240′ Module housing
HA Rear axle
pBA Trailer brake pressure
pS1 Primary control pressure
pS2 Secondary control pressure
pV Reservoir pressure
SD1 Primary pressure signal
SD2 Secondary pressure signal
SS1 Primary electrical control signal
SS2 Secondary electrical control signal
VA Front axle

1. A trailer control module (1) for a brake system (202) of a tractor vehicle having a trailer which comprises a pneumatic brake system, the trailer control module (1) comprising:
at least a primary electrical port (10) for receiving a primary electrical control signal (SS1) and a secondary electrical port (12) for receiving a secondary electrical control signal (SS2),
a reservoir port (11) for receiving reservoir pressure (pV) from a compressed air source,
a trailer supply port (21) for providing reservoir pressure (pV) for the pneumatic brake system of the trailer,
a trailer brake pressure port (22) for providing a trailer brake pressure (pBA) for the pneumatic brake system of the trailer, and
a valve arrangement (4) which receives reservoir pressure (pV) from the reservoir port (11) and, depending on the primary and secondary electrical control signals (SS1, SS2), outputs the trailer brake pressure (pBA) at the trailer brake pressure port (22),
wherein the valve arrangement (4) has a primary pilot control unit (6) receiving the primary control signals (SS1) and a secondary pilot control unit (8) receiving the secondary control signals (SS2), wherein the primary pilot control unit (6) has a primary 3/2-way valve (16) as a primary inlet/outlet valve and the secondary pilot control unit (8) has a secondary 3/2-way valve (18) as a secondary inlet/outlet valve.

2. The trailer control module as claimed in claim 1, wherein the primary pilot control unit (6) has a primary pressure-holding valve (26) for holding a primary control pressure (pS1) output by the primary 3/2-way valve (16).

3. The trailer control module as claimed in claim 2, wherein the secondary pilot control unit (8) has a secondary pressure-holding valve (28) for holding a secondary control pressure (pS2) output by the secondary 3/2-way valve (18).

4. The trailer control module as claimed in claim 1, having a main valve unit (14) which is connected to the reservoir port (11) and receives reservoir pressure (pV) therefrom, and which is connected to the primary pilot control unit (6) and to the secondary pilot control unit (8) and receives the primary control pressure (pS1) and the secondary control pressure (pS2) therefrom and, depending on the primary control pressure (pS1) and the secondary control pressure (pS2), outputs the trailer brake pressure (pBA) at the trailer brake pressure port (22).

5. The trailer control module as claimed in claim 1, wherein the primary 3/2-way valve (16) has a first 3/2-way valve port (16.1) that is connected or connectable to the reservoir port (11), a second 3/2-way valve port (16.2) that is connected or connectable to a vent (3), and a third 3/2-way valve port (16.3) that is connected to a first control pressure line (17), wherein in a first, deenergized switch position of the primary 3/2-way valve (16), the second 3/2-way valve port (16.2) is connected to the third 3/2-way valve port (16.3), and in a second, energized switch position of the primary 3/2-way valve (16), the first 3/2-way valve port (16.1) is connected to the third 3/2-way valve port (16.3) in order to output the primary control pressure (pS1) into the first control pressure line (17).

6. The trailer control module as claimed in claim 5 any wherein the secondary 3/2-way valve (18) has a fourth 3/2-way valve port (18.1) that is connected or connectable to the reservoir port (11), a fifth 3/2-way valve port (18.2) that is connected or connectable to a vent (3), and a sixth 3/2-way valve port (18.3) that is connected to a second control pressure line (19), wherein in a first, deenergized switch position of the secondary 3/2-way valve (18), the fifth 3/2-way valve port (18.2) is connected to the sixth 3/2-way valve port (18.3), and in a second, energized switch position of the secondary 3/2-way valve (18), the fourth 3/2-way valve port (18.1) is connected to the sixth 3/2-way valve port (18.3) in order to output the secondary control pressure (pS2) into the second control pressure line (19).

7. The trailer control module as claimed in claim 4, wherein the main valve unit (14) has a relay valve (15), having a first relay valve port (15.1) that is connected or connectable to the reservoir port (11), a second relay valve port (15.2) that is connected to the trailer brake pressure port (22) and outputs the trailer brake pressure (pBA), a third relay valve port (15.3) that is connected to a vent (3), and at least one first relay valve control port (15.4) for receiving the primary control pressure (pS1).

8. The trailer control module as claimed in claim 7, wherein
the secondary control pressure (pS2) is also provided to the first relay valve control port (15.4), or
the relay valve (15) has a second relay valve control port (15.5) that receives the secondary control pressure (pS2).

9. The trailer control module as claimed in claim 1, wherein the primary 3/2-way valve (16) and/or the secondary 3/2-way valve (18) is in the form of a bistable valve (20).

10. The trailer control module as claimed in claim 1, having a breakaway emergency valve (30) which is arranged pneumatically at least between the reservoir port (11) and the trailer supply port (21).

11. The trailer control module as claimed in claim 1, wherein the primary switching signals (SS1) are provided by a primary electronic control unit (100) and the secondary switching signals (SS2) are provided by a secondary electronic control unit (110), wherein the primary and the secondary electronic control unit (100, 110) are independent of one another and are at least partially redundant.

12. The trailer control module as claimed in claim 11, wherein the secondary electronic control unit (110) is integrated with the trailer control module (1).

13. The trailer control module as claimed in claim 1, wherein the trailer control module (1) is integrated with an electronic air-treatment unit (130) of the brake system (202).

14. An electromechanical brake system (202) for a commercial vehicle, having a primary electronic control unit (100) and a secondary electronic control unit (110), a first power source (210), which supplies the primary control unit (100) with electric power, and a second power source (220), which supplies the secondary control unit (110) with electric power;
at least a first and second electromechanical front-axle brake actuator (230a, 230b) and at least a first and second electromechanical rear-axle brake actuator (232a, 232b), which are controllable by the primary control unit (100) and the secondary control unit (110) in order to implement a brake demand; and
a trailer control module (1) as claimed in claim 1, wherein the primary control unit (100) is connected to the primary electrical port (10) and provides the primary switching signals (SS1) to the primary electrical port (10), and the secondary control unit (110) is connected to the secondary electrical port (12) and provides the secondary switching signals (SS2) to the primary electrical port.

15. The electromechanical brake system (202) as claimed in claim 14, wherein the trailer control module (1) has a trailer control module housing (1′) and is constructed as an independent module in the brake system (202).

16. The electromechanical brake system (202) as claimed in claim 14, wherein the trailer control module (1) and the secondary control unit (110) are integrated to form a module.

17. The electromechanical brake system (202) as claimed in claim 14, having an electronic air-treatment unit (130), wherein the trailer control module (1) and the electronic air-treatment unit (130) are integrated to form a module.

18. A commercial vehicle (200) having a front axle (VA) and at least one rear axle (HA), and an electromechanical brake system (202) as claimed in claim 14.

19. The trailer control module as claimed in claim 4, wherein the main valve unit (14) is a common valve unit for both pilot control units which outputs the trailer brake pressure regardless of whether the trailer brake pressure is demanded via the primary control pressure or the secondary control pressure.

20. The trailer control module as claimed in claim 8, wherein the relay valve (15) has the second relay valve control port (15.5) that receives the secondary control pressure (pS2), and wherein primary and secondary holding valves, which are respectively disposed between the primary and secondary inlet/outlet valves and the first and second relay valve control ports, are open in a deenergized state and closed in an energized state.
